(19) United States
(12) Patent Application Publication
(10) Pub. No.: US 2010/0074086 A1
(43) Pub. Date: Mar. 25, 2010

(54) OPTICAL DISK DEVICE

(75) Inventors: Kazuki Kajikawa, Osaka (JP); Toshiaki Fukui, Osaka (JP)

Correspondence Address: PILLSBURY WINTHROP SHAW PITTMAN, LLP, P.O. BOX 10500, MCLEAN, VA, 22102, US

(73) Assignee: Funai Electric Co., Ltd., Osaka (JP)

(21) Appl. No.: 12/560,830

(22) Filed: Sep. 16, 2009

(30) Foreign Application Priority Data
Sep. 19, 2008 (JP) 2008-240454

(51) Int. Cl. G11B 7/00

(52) U.S. Cl. 369/100; G9B/7

(57) ABSTRACT

This optical disk device includes a pickup, a replay means, and an adjustment means. The pickup irradiates laser light upon an optical disk. And the pickup receives light reflected back from the optical disk, performs photoelectric conversion thereupon, and outputs an electrical signal. The replay means adds an offset voltage to an RF signal generated from the electrical signal, and performs replay by processing the RF signal. The adjustment means measures the error rate of the RF signal while changing the value of the offset voltage. And the adjustment means adjusts the offset voltage to that voltage at which the error rate is the lowest. During replay, the replay means adds to the RF signal this offset voltage which has been thus adjusted.

### CROSS REFERENCE

This Nonprovisional application claims priority under 35 U.S.C. § 119(a) on Patent Application No. 2008-240454 filed in Japan on Sep. 19, 2008, the entire contents of which are hereby incorporated by reference.

### BACKGROUND OF THE INVENTION

The present invention relates to an optical disk device which irradiates laser light upon an optical disk and replays a RF signal which is obtained from the light reflected back from the optical disk, and in particular relates to an optical disk device which adjusts an offset voltage.

From the past, optical disk devices which perform reading of data from optical disks and/or recording of data upon optical disks have been per se known and widespread. These optical disks may be, for example, Blu-ray disks or DVDs.

A plurality of light reception elements are provided to such a prior art optical disk device for receiving the reflected portion of the laser light which is irradiated upon the optical disk. And, with a typical such prior art optical disk device, by amplifying the electrical signals outputted from these light reception elements, an RF signal, a focus error signal, and a tracking error signal are obtained. This RF signal is a read signal for the data which is recorded upon the optical disk.

An offset occurs due to the dark current in these light reception elements. Moreover, an offset also occurs in the amplifier. When this type of offset occurs, errors are included in the RF signal, and the error rate of the RF signal becomes higher. As a result, sometimes an erroneous signal is replayed, which is undesirable.

Thus, with a prior art optical disk device of the type described above, an offset voltage is adjusted so as to cancel out these offsets.

It should be understood that, in Japanese Laid-Open Patent Publication Heisei 11-134653, an optical disk device is disclosed in which the intensity of the laser is adjusted.

However, if the optical disk is a malfunctioning disk upon which the state of the data recording surface is bad, then the error rate of the RF signal is not limited to being minimal by the value to which the offset voltage which has been adjusted.

Moreover, if the optical disk is a malfunctioning one, then the quality of the RF signal which is obtained is bad. Due to this it is also sometimes the case that, because of the value of the error rate, it is not possible for such a prior art type optical disk device to replay this optical disk in an adequate manner. For example, with such a prior art type optical disk device, the problem may occur that, during replay, the image is interrupted or the audio is interrupted.

Accordingly, if an optical disk is a malfunctioning one, it is necessary to keep down the error rate to as low as possible.

The object of the present invention is to provide an optical disk device with which it is possible to adjust the offset voltage to an optimum value according to the state of the recording surface, thus keeping down the error rate and making it possible to provide adequate replay quality even in the case of an optical disk which is malfunctioning.

### SUMMARY OF THE INVENTION

The optical disk device according to the present invention includes a pickup, a replay means, and an adjustment means. The pickup irradiates laser light upon an optical disk. And the pickup receives light reflected back from the optical disk, performs photoelectric conversion thereupon, and outputs an electrical signal. The replay means adds an offset voltage to an RF signal generated from the electrical signal, and performs replay by processing the RF signal. The adjustment means measures the error rate of the RF signal while changing the value of the offset voltage. And the adjustment means adjusts the offset voltage to that voltage at which the error rate is the lowest.

During replay, the replay means adds to the RF signal this offset voltage which has been thus adjusted. And the replay means processes the RF signal from which the offset has been eliminated, thus performing replay. Due to this, the optical disk device having this structure replays an optical disk in the state in which the error rate is the lowest.

### BRIEF DESCRIPTION OF THE DRAWINGS

FIG. 1 is a block diagram showing the structure of the main portion of an optical disk device according to an embodiment of the present invention;

FIG. 2 is a figure showing an example of an eye pattern obtained by replaying an optical disk;

FIG. 3 is a flow chart showing operation performed in an offset re-adjustment mode by a control unit of this optical disk device according to an embodiment of the present invention;

FIG. 4 is a figure showing results of block error rate measurement of a normal optical disk and a malfunctioning optical disk; and

FIG. 5 is a flow chart showing operation performed during offset adjustment processing by this control unit of the optical disk device according to an embodiment of the present invention.

### DETAILED DESCRIPTION OF THE INVENTION

In the following, an optical disk device which is an embodiment of the present invention will be explained.

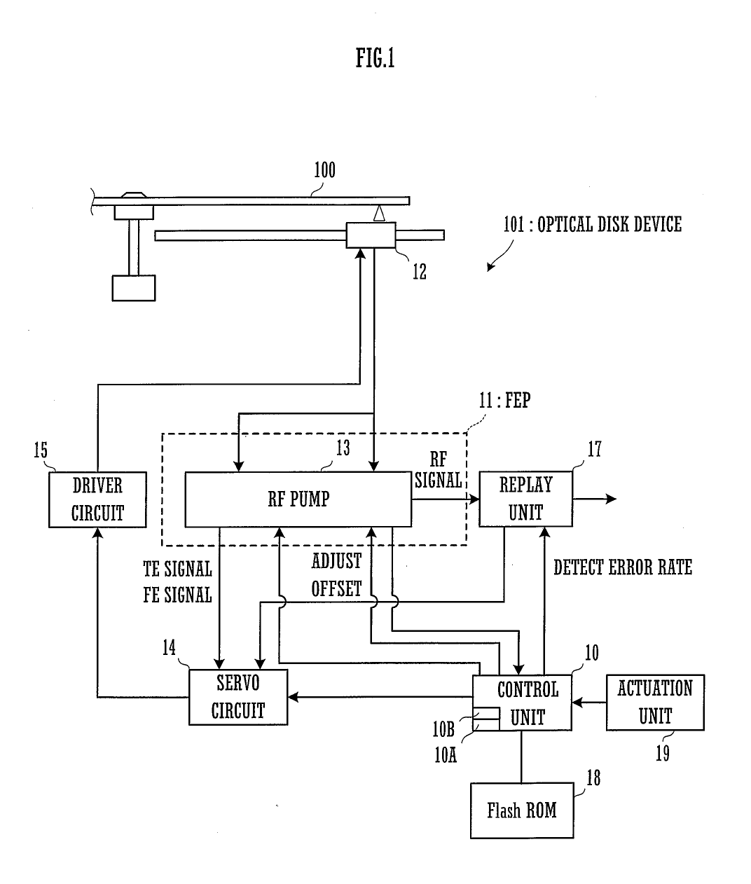

FIG. 1 is a block diagram showing the structure of the main portion of an optical disk device according to an embodiment of the present invention. This optical disk device 101 comprises a control unit 10, a pickup 12, an FEP (front end processor) 11, a servo circuit 14, a driver circuit 15, a replay unit 17, a flash ROM 18, and an actuation unit 19. The FEP 11 is a processor which controls the front end side processing. This FEP 11 includes an RF amp 13.

This optical disk device 101 is a so called Blu-ray player. The optical disk 100 is, for example, a Blu-ray disk or a DVD. It should be understood that although, in this embodiment, the case of a Blu-ray player is explained, the present invention could also be applied to a Blu-ray recorder.

The pickup 12 irradiates laser light upon the optical disk 100 which is loaded in the optical disk device 101. And the pickup 12 detects the light reflected back from the optical disk 100.

This pickup 12 includes a laser diode (hereinafter referred to as the “LD”), a collimator lens, a beam splitter, an objective lens, a photodetector, a thread motor, and a two-axis actuator.

The pickup 12 is fitted upon an axis which extends along the radial direction of the optical disk 100, so as to be able to shift along that axis. And the thread motor shifts the pickup along the radial direction of the optical disk 100.

The LD is a light source which outputs laser light.

Moreover, the photodetector is formed from a plurality of light reception elements. The photodetector detects (i.e. performs photoelectric conversion upon) the light reflected back from the optical disk 100 with this plurality of light reception elements.

The objective lens adjusts the position at which the laser light is irradiated upon the optical disk 100. Moreover, the two-axis actuator shifts the objective lens in the direction towards and away from the optical disk 100, and in the radial direction of the optical disk 100.

The RF amp 13 generates a focus error signal (hereinafter termed the “FE signal”) on the basis of the light which is reflected back from the optical disk 100 and detected by the photodetector. Moreover, this RF amp 13 generates a tracking error signal (hereinafter termed the “TE signal”) on the basis of the light which is reflected back from the optical disk 100 and detected by the photodetector. The RF amp 13 includes an AGC circuit which adjusts the gains for the FE signal and the TE signal. The RF amp 13 amplifies the FE signal and the TE signal by the gains which have thus been adjusted. And the RF amp 13 outputs this FE signal and the TE signal which have thus been amplified to the servo circuit 14.

On the basis of the FE signal and the TE signal which are outputted by the RF amp 13, the servo circuit 14 generates a focusing servo signal for setting the value of the FE signal to 0 (a reference level), and a tracking servo signal for setting the value of the TE signal to 0 (a reference level). And the servo circuit 14 outputs this focusing servo signal and tracking servo signal which it has generated to the driver circuit 15.

By supplying the focusing servo signal to the actuator, the driver circuit 15 shifts the objective lens of the pickup 12 along the direction of the optical axis with respect to the optical disk 100. By doing this, the driver circuit 15 performs focusing servo control to focus the laser light upon the recording surface of the optical disk 100.

Moreover, by supplying the tracking servo signal to the actuator, the driver circuit 15 shifts the objective lens of the pickup 12 along the radial direction of the optical disk 100. By doing this, the driver circuit 15 performs tracking servo control to irradiate the laser light upon the center of the track upon the optical disk 100.

By performing the above described focus servo control and tracking servo control, the optical disk device 101 is able to keep the laser light following along the desired track, and also is able to keep the laser light focused upon this track. Moreover, with this optical disk device 100, spindle servo control of a spindle motor is also performed in order to rotate the optical disk 100 at a target rotational speed, but the arrangements for doing this are not shown in the figures.

Next, the block 17 which performs replay will be explained.

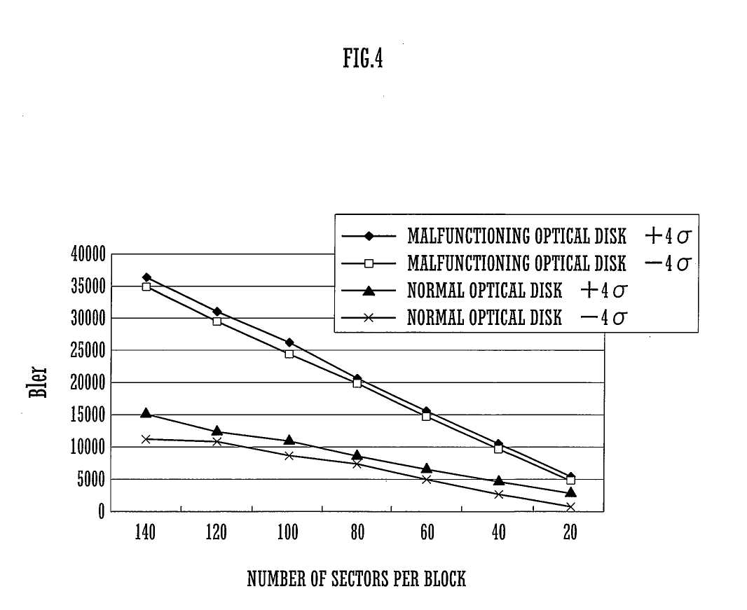

During replay, the pickup 12 irradiates laser light of read power upon the optical disk 100. And the pickup 12 detects the light reflected from the optical disk 100 with the photodetector (described hereinafter with reference to FIG. 4). By doing this, the information which is recorded upon the optical disk 100 is optically read out.

The RF amp 13 generates an RF signal on the basis of the light reflected back from the optical disk 100, which has been detected by the above described plurality of light reception elements which make up the photodetector provided to the pickup 12. Moreover, the RF amp 13 performs amplification of the RF signal, application of an offset voltage thereto, and so on. And the RF amp 13 outputs the resulting RF signal to the replay unit 17. This RF signal is a read signal for the data which is recorded upon the optical disk 100.

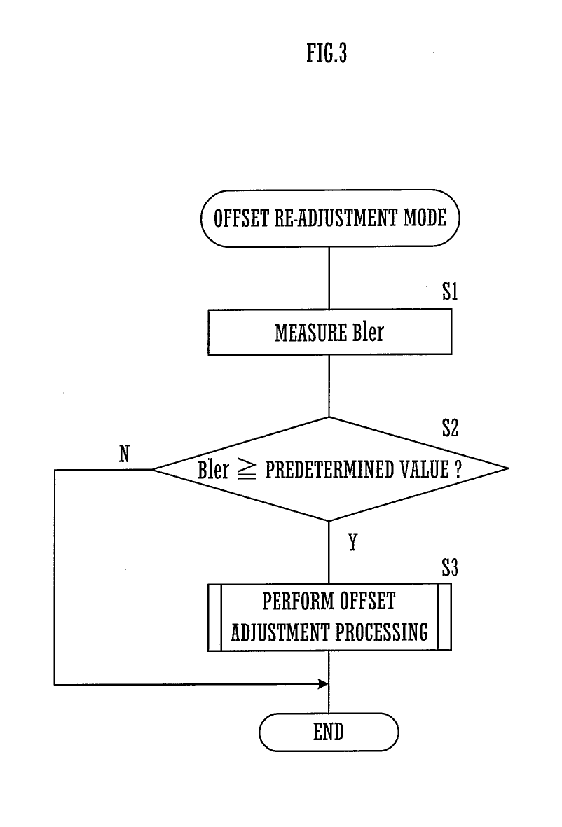

The replay unit 17 demodulates the RF signal and so on, and extracts data for video and audio and the like therefrom. And the replay unit 17 also performs error correction and error detection upon this data. Here, this replay unit 17 may, for example, perform error correction by Reed-Solomon codes. By using this type of communication path encoding method, the error rate of the data may be kept to a predetermined value (refer to the subsequent description of the step S2 of FIG. 3).

Furthermore, the replay unit 17 decodes the video and audio data, for example by MPEG, and generates a replay signal. And the replay unit 17 outputs this replay signal to a television or the like which is connected to this optical disk device. The user views the video and audio recorded on the optical disk 100 upon this display device.

The control unit 10 may be, for example, a microcomputer. This control unit 10 includes a RAM 10A which serves as a working space for deploying a control program and so on. This control program is a program in which methods for controlling the various modules of this optical disk device are described. And this control program is stored in a flash ROM 18, so that it can be updated.

The actuation unit 19 is a module for the user to input commands of various types to this optical disk device 100. Keys which are provided upon this actuation unit 19 include a replay key. These commands which are inputted by the user to the optical disk device 101 via the actuation unit 19 are transmitted to the control unit 10. Moreover, a remote control signal detection unit (not shown in the figures) is provided to the actuation unit 19. By using a remote control (also not shown in the figures) which communicates with this remote control signal detection unit, the user is able to input commands to the optical disk device 101 from the exterior.

The control unit 10 corresponds to the “adjustment means” of the Claims. Moreover, the RF amp 13 and the replay unit 17 correspond to the “replay means” of the Claims.

Next, the eye pattern which is obtained by replaying the optical disk will be explained. This eye pattern is the waveform of a high frequency signal which is obtained by totaling the output signals of all the photodetectors.

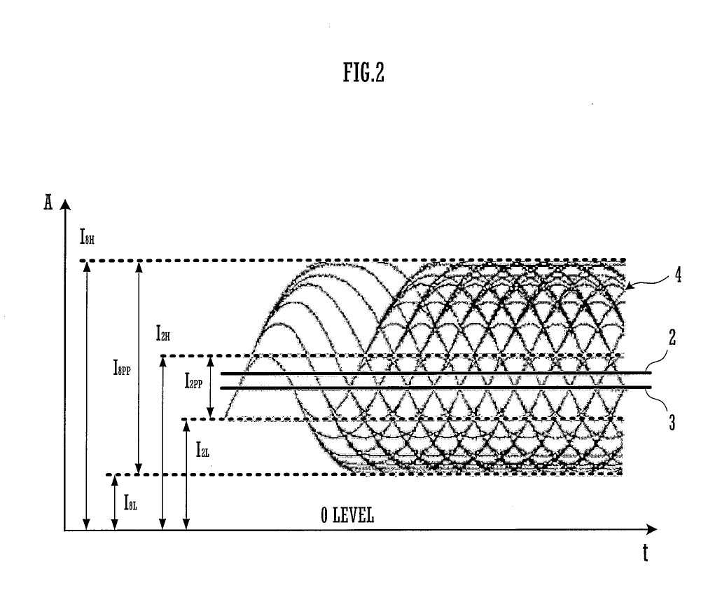

FIG. 2 is a figure showing an example of an eye pattern which is obtained by replaying an optical disk. In FIG. 2, the amplitude A of the signal with respect to time t is shown.

Due to the high data storage density of the optical disk 100, the modulation transmission function drops abruptly. Due to this, the high frequency component of the RF signal attenuates quite largely as compared to the low frequency component. If the optical disk 100 is a Blu-ray disk, the shortest run-length component (2T) is attenuated by about 20 dB as compared with the longest run-length component (8T). As shown for example in FIG. 2, the first differential between the highest level I_{8H} and the lowest level I_{8L} of the longest run-length component is much larger than the second differential between the highest level I_{2H} and the lowest level I_{2L} of the shortest run length component. Due to this, a large amount of interference takes place between the codes. Here, the first differential corresponds to the value I_{8PP} from peak to peak of the longest run-length component. And the second differential corresponds to the value I_{2PP} from peak to peak of the shortest run-length component.

Furthermore, as shown in FIG. 2, the intermediate level 2 of the longest run-length component is greatly different from the intermediate level 3 of the shortest run-length component. This asymmetry of the eye pattern 4 may be ascribed to non-optimum recording conditions, such as excessive write power. And sometimes the amount of this asymmetry is larger than the amplitude of the shortest run-length signal. Since the eye pattern is almost closed, with this asymmetry, errors are included in the RF signal and the error rate of the RF signal becomes high. As a result, an erroneous signal is replayed, which is undesirable.

Accordingly, in this embodiment, an adjustment unit 10B which performs offset adjustment processing is provided to the control unit 10, and executes operation as will now be described.

FIG. 3 is a flow chart showing operation performed by the control unit of this optical disk device which is an embodiment of the present invention during an offset re-adjustment mode. This operation is performed when either the optical disk 100 is loaded into the optical disk device 101, or the power supply to the optical disk device 101 is turned ON when it is in the state with an optical disk 100 already loaded. At this time, the control unit 10 transits to the offset re-adjustment mode after having rotated the optical disk 100 and adjusted the gain of the TE signal and so on.

First, by investigating one block of the video and audio data extracted by the replay unit 17, the control unit 10 measures the block error rate (hereinafter termed “Bler”) (a step S1). The number of sectors on each block is, for example, forty sectors. Moreover, the error rate is a value calculated according to the relationship “error rate=number of erroneous bits/number of data bits”.

FIG. 4 is a figure showing the results of measurement of the block error rates of a normal optical disk (i.e. for one which is functioning nominally) and of a malfunctioning optical disk. The block error rate is shown along the vertical axis in this figure, while the number of sectors per one block is shown along the horizontal axis. The control unit 10 measures Bler in the above step S1, as shown in FIG. 4. And, as shown in FIG. 4, the Bler for a normal optical disk and the Bler for a malfunctioning optical disk are different. And problems occur when the malfunctioning optical disk is replayed, such as interruptions of the video during replay or interruptions of the audio.

It should be understood that the measurement of Bler in the step S1 may, for example, be performed by a first measurement method or a second measurement method. The first measurement method is a method in which the control unit 10 checks error correction bits and/or error detection bits which are included in the video and audio data extracted by the replay unit 17. And the second measurement method is a method in which the control unit 10 compares together data which was extracted by the replay unit 17 when a normal optical disk which was loaded in the past was replayed, and data which is extracted by the replay unit 17 when the optical disk 100 which has been loaded this time is replayed. The number of blocks per one sector is set in advance to a value with which the Bler of a normal optical disk the Bler of a malfunctioning optical disk can be told apart (refer to FIG. 4). Here, since the time period which is needed for the processing in the step S1 also increases when the number of sectors per one block increases, it is desirable for it to be set to the minimum appropriate value. One block may be, for example, forty sectors.

Next, the control unit 10 decides whether or not the Bler which was measured in the step S1 described above is greater than or equal to a predetermined value (a step S2). This predetermined value should be set based upon whether or not adequate replay can be performed, and may, for example, be set to 8000 (refer to FIG. 4).

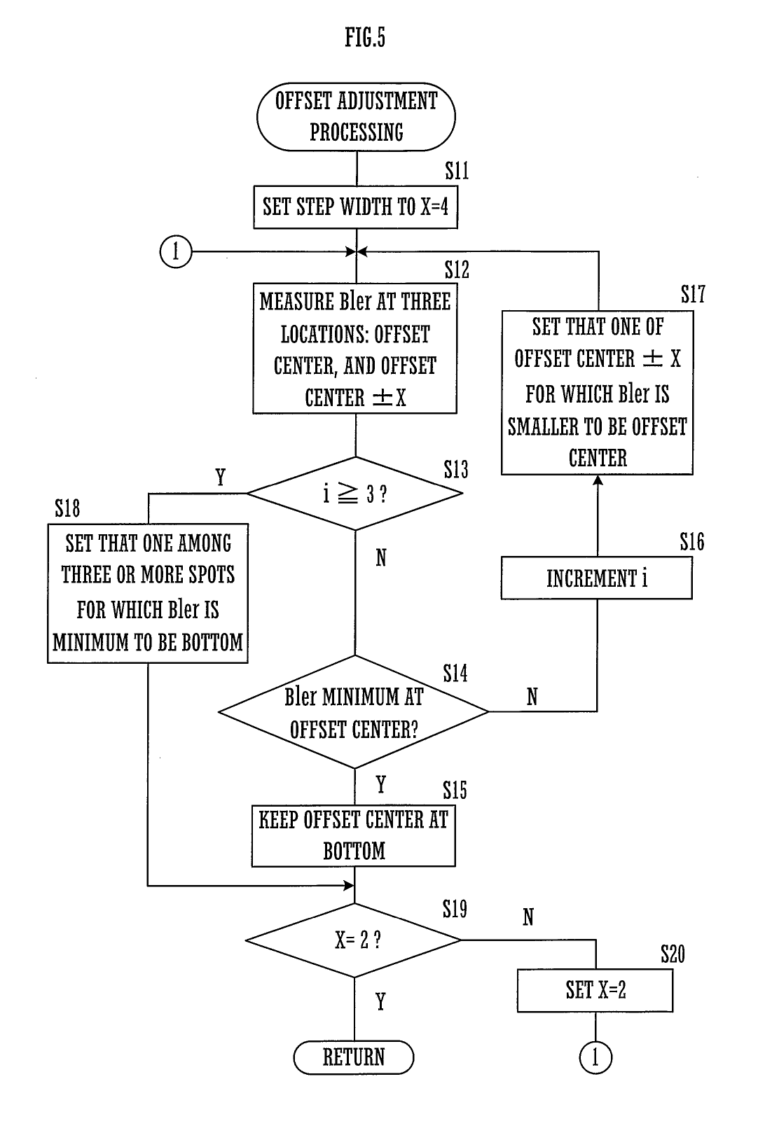

If in the step S2 it has been decided that Bler is less than the predetermined value, then the control unit 10 prohibits execution of offset adjustment processing, and this processing sequence terminates. If Bler is less than the predetermined value, then this means that the optical disk 100 is a normal optical disk which can be replayed in an adequate manner. Due to this, there is no need for the control unit 10 to perform re-adjustment of the offset. Thus, the control unit 10 prohibits execution of the offset adjustment process. Due to this, the re-adjustment of the offset shown in FIG. 5 which will be described hereinafter is only performed for an optical disk which is malfunctioning. Accordingly, it is possible to prevent unnecessary processing being performed for undesirably performing re-adjustment of the offset of a normal optical disk.

On the other hand, if in the step S2 the control unit 10 has decided that Bler is greater than or equal to the predetermined value, then offset adjustment processing is executed (a step S3). In concrete terms, the control unit 10 measures the error rate of the RF signal generated by the RF amp 13 while changing the value of the offset voltage. And, in concrete terms, the offset voltage is adjusted to that voltage for which the error rate is the lowest. This offset adjustment processing is based upon the theory that, upon a malfunctioning optical disk, a large number of pits are distorted, and that, if the offset voltage is adjusted to match the pits which are distorted, the error rate of the RF signal will be reduced.

FIG. 5 is a flow chart showing operation performed during offset adjustment processing by the control unit of this optical disk device according to an embodiment of the present invention. In this operation, in a first stage, the value of the offset voltage is squeezed down by taking the step width wide as x=4, and, in a second stage, the value of the offset voltage is confirmed by taking the step width narrower, as x=2.

It should be understood that, although in this embodiment x=4 and x=2 are employed, it is not necessary for another implementation to be limited to these values.

First, the control unit 10 sets the step width to x=4 (a step S11). The offset width is the value of displacement from the offset voltage value which is currently set (hereinafter termed the “offset center”). Moreover, the value x=1 may, for example, correspond to 0.1 mV. In other words, x=4 may correspond to 0.4 mV and x=2 may correspond to 0.2 mV.

Next, the control unit measures Bler at the offset center, Bler at the offset center+x, and Bler at the offset center−x (a step S12). Here, this measurement of Bler in the step S12 is done in the same way as the measurement of Bler in the step S1 of FIG. 3.

It should be understood that while, in this embodiment, Bler is measured at three spots, this is not necessarily limitative of the present invention. In a different implementation Bler could be measured at more than three spots—for example, Bler could be measured at five spots.

The control unit 10 then decides whether or not the count value i (for i=1 . . . n) is greater than or equal to 3 (a step S13). The count value i is the number of times that the offset center has not been the minimum.

If the count value i is less than 3, then the control unit 10 decides whether or not Bler at the offset center is the minimum among the three spots (a step S14). If Bler at the offset center is the minimum among the three spots, then the control unit 10 keeps the value of the offset center which is currently set (a step S15).

On the other hand, if in the step S14 it is determined that Bler at the offset center is not the minimum among the three spots, then the control unit 10 adds 1 to the count value i (a step S16). And the control unit 10 sets the one of (the offset center+x) and (the offset center−x) for which Bler is the smaller, to be the offset center (a step S17). Then the control unit 10 returns the flow of control to the step S12 and continues the processing.

Furthermore, if the count value i in the step S13 is 3 times or greater, then the control unit 10 sets that one among these three or more spots for which Bler is the minimum to be the offset center (a step S18). And then the control unit 10 proceeds to a step S19.

Finally, the control unit decides whether or not the step width x=2 (a step S19). If the step width is not x=2, then the control unit sets the step width to x=2 (a step S20), and then returns the flow of control to the step S12 and continues processing. At this time, the count value i may also be reset.

And, if the step width x=2, then the control unit 10 terminates this subroutine. And then the control unit returns control to the main routine shown in FIG. 3.

As described above, the control unit 10 measures the error rate of the RF signal while changing the value of the offset voltage, and adjusts the offset voltage value to that value for which the error rate is the lowest. Due to this, during replay, the RF amp 13 adds this offset voltage which has been adjusted by the above offset adjustment processing to the RF signal. This makes it possible for this optical disk device 101 to replay the optical disk 100 in that manner in which the error rate is the lowest. Accordingly, even if the optical disk 100 is a malfunctioning optical disk, due to the above described offset adjustment processing, it becomes possible for the optical disk device 101 to replay it.

Furthermore, the following variant embodiment of the present invention may be employed.

An offset adjustment key may be provided to the actuation unit 19, for receiving a command to execute the above described offset re-adjustment mode. And, when the user depresses this offset adjustment key, the control unit 10 may execute the offset re-adjustment mode shown in FIG. 3. And, when the control unit has decided, in the step S2, that Bler is less than the predetermined value, the operation shown in FIG. 5 may be performed. Due to this, the user is able to adjust the offset voltage to the optimum value at any timing which he may desire. Accordingly, the convenience of use from the point of view of the user is enhanced by yet a further level.

Finally, all of the features described in the explanation of this embodiment given above are only cited by way of example, and must not be viewed as being limitative of the present invention in any way. The scope of the present invention is not defined by the embodiment described above, but only by the range of the Claims. Moreover, all changes which are equivalent in meaning and scope to the scope of the Claims, are intended to be included within the range of the present invention.

What is claimed is:

1. An optical disk device, comprising:
a pickup which irradiates laser light upon an optical disk which is loaded, receives light reflected from said optical disk with a light reception element, photoelectrically converts that light to produce an electrical signal, and outputs that electrical signal;
a replay means which generates an RF signal from said electrical signal outputted from said pickup, adds an offset voltage to said RF signal, and performs replay by processing said RF signal; and
an adjustment means which performs offset adjustment processing by measuring the error rate of said RF signal generated by said replay means while changing the value of said offset voltage, and adjusting said offset voltage to that value which results in the lowest error rate;
wherein, during replay, said replay means adds to said RF signal the offset voltage which has been adjusted by said offset adjustment processing.

2. An optical disk device according to claim 1, wherein said adjustment means:
comprises a decision unit which, when said optical disk is loaded into said optical disk device, or when the power supply to said optical disk device is turned ON with said optical disk loaded, measures the error rate of said RF signal outputted from said pickup, and decides whether or not this error rate is greater than or equal to a predetermined value;
executes said offset adjustment processing if said decision unit has decided that said error rate is greater than or equal to said predetermined value; and
prohibits execution of said offset adjustment processing if said decision unit has decided that said error rate is less than said predetermined value.

3. An optical disk device according to claim 1, further comprising an actuation means which receives a command for execution of said offset adjustment processing by said adjustment means.

4. An optical disk device according to claim 1, wherein said optical disk is a Blu-ray disk or a DVD.
